(19) United States
(12) Patent Application Publication
(10) Pub. No.: US 2009/0148812 A1
(43) Pub. Date: Jun. 11, 2009

(54) Device for Dispensing Active or Passive Substance Embedded in the Oral Cavity

(76) Inventor: Erella Pines, Pardes Hannah (IL)

Correspondence Address: Hershkovitz & Associates, LLC, 2845 Duke Street, Alexandria, VA, 22314, US

(21) Appl. No.: 12/065,737

(22) PCT Filed: Oct. 25, 2006
(86) PCT No.: PCT/IL06/01227

§ 371 Date: Mar. 5, 2008

(30) Foreign Application Priority Data
Oct. 27, 2005 (IL) 171649

(51) Int. Cl. A61J 7/00; B29C 47/06

(52) U.S. Cl. 433/80; 156/244.19

(57) ABSTRACT

The present invention relates to a device for retaining and dispensing substances embedded in the oral cavity, More particularly, said device includes at least one or more containers (reservoirs) which container stores the substance; should only one container be present at least one stopper is also present; and a cord which connects the above components and may function also as an anchorage.

The present invention relates to a device for dispensing active or passive substances embedded in the oral cavity, especially such being installed by the user himself or by a professional with or without an applicator and/or for a predefined or non defined period (permanently and temporarily).

There are known many preparations, compounds or the like which are inserted in the oral cavity of humans and animals which preparations may be gradually released over a period, preferably a prolonged period. Such preparations are in particular substances such as drugs, medicaments, antibiotics, nutrients, oral care agents and the like beneficial agents, compounds fighting against bad smell, food additives and may have pharmaceutical preparations, etc. Said preparation may have any suitable acceptable form, e.g. a preparation proper, a solution, a tablet, a pill, a gel, compositions, grinding preparations, etc.

There are known many such preparations, e.g. those described and claimed in Israeli Patent Specification No. 166,114.

Several approaches for long-term gastric retention devices are available. An intragastric floating system (N. Eng. J. Med. (1981) 304:1365-1366), high density system, a mucoadhesive system (“Advances in Drug Delivery Systems” J. M. Anderson and S. W. Kim, Eds, Elsevier, Amsterdam Vol 1, 1986, pp. 47-57), a magnetic system and more.

The diseases and conditions of dentition and of the oral cavity, on the other hand, have been targeted for timed-release chemicals or therapeutic substances which have been placed inside delivery devices intended to act for longer than 24 hours.

Other devices are known from:

U.S. Pat. No. 3,600,807 for the control of bad breath In this invention a cup or pocket is formed in a denture or in an artificial tooth in order to store and make available breath.

U.S. Pat. No. 3,386,440—The use of a medicated pad placed over the open socket of a freshly extracted tooth for the relief of pain and hemorrhage by placing long-acting medications locally in the vicinity of the inflamed gum or by introducing active substances directly into the disease-induced subgingival pockets (J. Periodontology (1984) 11:651-651).

U.S. Pat. No. 4,175,326, Goodson discloses capillary hollow fibers filled with the antibiotic tetracycline. These hollow fiber bands are slipped over each tooth, then rolled down into the periodontal pocket in order to achieve a high local concentration of the antibiotic. Such a device is generally only suited for a single localized application. It is not refillable and must be physically removed and a fresh device reinstalled for additional applications.

Cox in U.S. Pat. No. 4,959,052 discloses an oral applicator for the application of an active substance in the form of a hollow structure corresponding substantially in shape and dimensions to an external form of a crown of one or more natural teeth and adapted to contain the active substance.

Ton in U.S. Pat. No. 4,671,768 describes an implant which when implanted in the cavity may contain a medicine for protecting the implant against pathogenic bacteria, etc.

U.S. Pat. No. 5,074,478 Woodward—The system uses a holder for retaining and protecting intra-oral fluoride tablets or other intra-oral medicament in the form of fluoride releasing devices (IFRD). Previous attempts to retain IFRD's in the mouth have failed for a variety of reasons. For instance, IFRD's produced by Southern Research Institute were designed to be bonded directly to the teeth.

These IFRD's were found susceptible to debonding from masticatory forces or were subject to excessive wear caused by abrasives contained in toothpastes.

DE-OS 32 10 242 discloses a technique based on inserting into the organism's jawbone a tooth implant in which openings are made through which the medicaments are fed directly into the blood stream.

U.S. Pat. No. 4,681,544 to Anthony discloses a device for positioning and retaining an oral pack for protecting a surgical site.

U.S. Application No. US 2003/0046954 discloses a tongue and mouth stud for dispensing a substance such as a chemical, breath freshener, pleasant flavor, or medication into the mouth of a wearer. This tongue and mouth stud includes a means for dispensing a substance comprised of an internal cavity for storing and dispensing the substance contained within through one or more openings in the surface of the tongue stud that are contiguous with the internal cavity. Furthermore, the means for dispensing a substance may include a sponge positioned within the internal cavity of the mouth and tongue stud.

U.S. Pat. No. 3,754,332 discloses a member for use in the treatment of caries in the teeth with fluoride or other chemicals which are carried by a section of the member which may be detachable. The member is worked between two teeth at a contact area to place the detachable section in contact with the teeth. The chemical agent is applied to the detachable section either before or after it is placed in contact with the teeth. The detachable section remains between the teeth when the rest of the member is removed, and preferably dissolves in the mouth when wet.

U.S. Pat. No. 4,215,478 discloses an article of manufacture for use in dental hygiene. The device provides a leader, to which there is attached a thicker “mop” which can be comprised of a plurality of individual string members. The string members can be abrasive to enhance cleaning action. The several string members which form the “mop” would preferably have some absorbent quality in order to retain a desired therapeutic aid such as fluoride or the like. The strings could be alternatively fluoride impregnated. In use, the leader is first passed between gaps in the teeth until the “mop” portion contacts the gap. Sliding action of the abrasive mop between the teeth removes undesirable plaque and massages the gums. In the method of the present invention, individual thread members are added to the leader so that as many strings are placed between the teeth as possible without causing discomfort and the space between the teeth can be filled.

U.S. Pat. No. 4,576,190 discloses a sanitary, hygienic dental/oral appliance synergistically combining six functions in one device to conveniently and even disposably provide for complete dental/oral hygiene in a portable package. A complete dental/oral hygiene device comprising a hypotraumatic (non-abrasive), large working/brushing-surface headpiece mounted upon a shaft. The shaft proximal end is adapted for scraping and stain removing. A flexible toothpick mounted upon the shaft as well as a measure of dental floss with a cover holds the floss in place. Also described as a fibro-cellular (spongy), bristle-free, first absorbent toothbrush, preimpregnated with fluoride gel/toothpaste, combined with a novel “winged toothpick”, dental floss, stain scraper and gum/teeth stimulator/vibrator tips, for easy-to-use, economically very pleasant, pain-free, comprehensive and complete dental/oral hygiene program.

U.S. Pat. No. 6,106,286 discloses a dental loop for delivering Coenzyme Q10 to the periodontium by direct physical contact therewith, and a method using such loop. The loop is a loop of plain gut defining a series of pockets for carrying a medicament. Coenzyme Q10 is placed within the pockets, so that it is available directly at the site to which said loop is applied. The loop is slipped over a tooth and placed against the periodontium, and left in place for sufficient time for the Q10 to dissolve and act, and the loop dissolve.

U.S. Pat. No. 6,326,022 discloses low-cost disposable elastomeric devices which are conveniently insertable to grip between teeth and are easily removable. The devices contain substances such as odorants or medications which slowly permeate into the mouth. The preferred embodiment has a mushroom shaped head, containing the active substance, with a stem that engages between teeth to hold the device in place. However said device is inconvenient, and it is even impossible use it in the posterior region of the mouth. Furthermore, said device is composed also of the active material, e.g. the substances, i.e. the polymeric material constitutes also the matrix for the substance. Moreover, there is no control over the release of the substance.

None of these suggested methods of therapeutic treatment has been wholly satisfactory nor widely adopted and accepted, due to a variety of causes and disadvantages associated with each technique.

The prolonged delivery of drugs and other substances orally has been a major challenge and a long desired objective in drug therapy. The successful accomplishment of prolonged oral drug delivery has great therapeutic significance in the treatment of various diseases including side effects, symptoms and appropriate conditions.

Systemic and transdermal sustained drug delivery systems have been developed which are capable of delivering constant amounts of therapeutic substances from several days to several months. The major limitation to long-term oral delivery, however, is the 8-16 hour gastrointestinal transit time of an ingested substance. In order to achieve uninterrupted action for longer than 24 hours by a therapeutic substance, its passage needs to be slowed in the gastrointestinal tract or the delivery device supplying the drug has to be fixed or immobilized within the tract. Many of the orally administered drugs are absorbed efficiently in the upper gastrointestinal tract (the stomach, and the proximal section of the small intestine). The self usage delivery device will enable prolonging the retention time of drugs in the upper G.I. Tract.

In the oral cavity there are many diseases and conditions which have to be treated, e.g. aphtostomatosis or candidiasis. The Self Usage Delivery device will enable prolonging the desired retention time of drugs in the oral cavity.

However, it has been rather difficult to design a device which will be suitable to release in an easy and comfortable manner such a substance, e.g. a preparation in particular for a variable period of time, e.g. from a few hours and more.

Thus, there is a need for a device which is working for a long time, e.g. which releases any material such as substances for sustained action and/or said device may be replaced by another device at any required time. Such a device may be called, e.g. Holder Over Night. However it is not restricted for night use.

A need exists, therefore, for an improved oral drug retaining device for administration of, inter alia, pharmacologic agents within the oral cavity. Such a device should be simple to install and provide protection from physical damage. As such, unlike the prior art devices discussed above, this device will not be limited to administering medication for dental applications. Instead, the device will also be adapted for retaining drugs or pharmacologic agents, utilized in treating a wide range of afflictions throughout the body, for absorption directly through the oral mucosal epithelium. It will also be utilized to allow certain drugs or agents to be systemically released via ingestion in the oral cavity and also through the gastrointestinal tract in a slow continuous time released fashion.

Interval of the pharmacologic agents in the oral cavity enable treatments of specific diseases and conditions and side effects that take place especially in the mouth.

More specifically the invention is in the field of sustained release devices for administering substances, e.g. drugs orally. In particular the invention thus relates to systems for retaining and dispensing medications, beneficial agents or other substances intraorally for sustained-controlled release by the saliva in an advance period of time and to devices for use within the mouth as an effective long-term oral and gastric retention device.

The present invention thus consists in a device for retaining and dispensing substances embedded in the oral cavity.

The present invention thus consists in a device for retaining and dispensing a substance which device includes one or more containers (reservoirs) for the storage of the substance and a cord which may function also as an anchorage. Said device is to be used for the administration of substances through the mouth. Said substances may be used against mouth diseases and side effects in the mouth, nutrition as well as for the diseases and nutrition of the G.I. tract to deliver biologically active entities with pharmacological activity.

The present invention thus provides a device which can be safely placed and securely retained in the mouth for a predefined or undefined period without the need of bonding the device to teeth, to a plate or to any additional devices and which may store the substance to be dispensed.

The present invention may thus consist, inter alia, a device which consists in a device for retaining and dispensing a substance which includes at least one or more containers (reservoirs) which container stores the substance; should only one container be present at least one stopper is also present; and a cord which connects the above components and may function also as an anchorage. Further a support arm may be present. The stopper may be a separate part or an integral part of the cord and/or of the support arm. The container(s), the stopper if present, the cord and the support arm if present may be designed as one component or alternatively being as different parts. Identical or different materials being incorporated in the containers, the container being the storage for all substances which have to be dispensed.

The container may be placed on one or more sides of the device, i.e. of the cord, e.g. in one possibility at least one container is located on the cord between two stoppers. Should more than one container be present, all containers may connected to each other by the cord. In one possibility the cord may be inserted through the container(s). In another possibility at least one container is located between at least two cords, and at the end of each cord is located a stopper. In yet another instance the one side of the device, i.e. of the cord, is provided with a container and in this case the second side is a stopper, in a further instance the device is provided on each side of the cord with a container and in yet a further instance the device may be constructed in such a manner that on each side, i.e. of the cord there is located one or more container. In all possibilities the container(s) and/or the stopper(s) can move along the cord(s) or be in a fixed position which fixed position is the preferred embodiment of the stopper(s).

The device according to the present invention also comprises a device for patients who have orthodontic treatment or instrumentation.

The orthodontic treatment may be performed in the following possibilities:
After finishing the orthodontic bonding on the teeth, the physician and/or the patient will apply the device, e.g. by the stretching of the cord between two hooks (like using orthodontic elastics) or by the putting of the cord on at least one hook, preferably on two hooks. The hooks are part of routine orthodontic brackets.
After sticking the brackets on each tooth and before inserting the orthodontic wire, the physician will apply the device, e.g. by the cord around the bracket which he has chosen. The physician can apply the device around one bracket or more according to his choice. The wire will hold the device in its place and will prevent its falling.

The container may be designed as one chamber or divided into several connected identical or non-identical chambers. The chambers may be segmented by a screen; or by a wall being permeable, non-permeable or semi-permeable. The substances, e.g. the medications might be slow delivered from each segment in a parallel regime or in different tempo, thus facilitating tailoring the dosage, and/or dosage regimen or the administration of a multiplicity of agents simultaneously or in a predetermined sequence. For instance: a first container (reservoir) comprises a dosage form adapted for pulsatile, delayed immediate, controlled, or any combination of delivery patterns, e.g. by passive control delivery, diffusion, erosion, osmotic, or any other mechanism or combination, and a second drug container (reservoir) if any comprises a dosage form which is coated by a special functional coating, designed to delay the delivery from the second container (reservoir) until the dosage form of the first container (reservoir) is empty. Should only one container be present, said container (reservoir) comprises a dosage form adapted for pulsatile, delayed immediate, controlled, or any combination of delivery patterns, e.g. by passive control delivery, diffusion, erosion, osmotic, or any other mechanism or combination.

The structure of the container may have many kinds of shapes e.g. cylindrical shape, round shape, “bagel” shape accommodating the shape and size of the substance, e.g. preparation, etc. and will suit and fit the substance, e.g. preparation in lengthwise time of the proceeding (so that the preparation will not “drop” from the device). The container may shrink with the substance, e.g. tablet or change shape and diameters in any other suitable manner or alternatively remains unchanged.

The outer surface of the container may be smooth or being provided with or consist in projections wherein said projections may be around the outer surface or only on part of the surface; and/or may be symmetrical or asymmetrical.

The container of the present invention may be designed as one unit or as at least one unit with a separate cover, e.g. the container body and the container cover. Furthermore, in addition to the above or instead of the above the container may have an opening to insert the substance.

The surface of the device, i.e. of the container according to the present invention may comprise at least one hole or perforation in any kind of structure such as a hole or a perforation per se, or a star structure, rectangular structure, etc. Preferably several holes or similar embodiments exist on the surface of the structure. Said holes serve that mouth fluids carries the substances, e.g. medication out of the container of the device into the mouth. The surface of the device may have a special feature. Said feature must enable the release which is located in the container. This may be, e.g., a membrane or any other materials or compounds which can control the release of the required substances.

Preferably, a hard outer shell includes at least one, and preferably several perforations for the drug delivery. Additionally or alternatively, a semi-pervious membrane may be used, for example on an apical side. In accordance with the present invention, one or several perforations and (or) semi-pervious membrane, may be operative in the controlled delivery of the substances, e.g. drug. Where necessary, filler may be used around the substances container, e.g. drug reservoir. Once placed in the oral cavity, the substances, e.g. drug is delivered to the oral cavity and (or) oral tissue, in a controlled manner, by a natural phenomenon.

In view of the above, the container may be made from a material through which may be released the substance. More particularly the container may be made from e.g. Biomedical silicons, Biomedical thermoplastic polyurethanes, Polyethylene, Ethylene vinyl acetate (EVA), etc.

The container of the device may be made of a soft and/or flexible material, such as polyurethane, a rubber-like material, a flexible plastic material, etc. The container may also be made from a material that encapsulates the substance, e.g. a pill like elastomer TPU. The container may be also made of rigid materials. All the materials are bio-compatible, insoluble in water, nonpoisonous, chemically inert and friendly to the user. In one embodiment in accordance with the present invention the container may be made of a three layered film produced by extrusion, e.g. coextrusion. The layers may be made, e.g. of two types of polymers, e.g.

1. polyolefin metallocene elastomer (hereinafter “material 1”) such as Engage 8500, and
2. linear triblock copolymer based on styrene and ethylene/butylenes, with a styrene content of 13% (hereinafter “material 2”) such as Kraton G 1657M. The film which is produced is advantageously symmetrical, namely material 1/material 2/material 1.

For the sake of clarity the terms “flexible”, “elastic”, “springiness” and “elastomeric” may have the same or similar interpretations.

The substance may be selected among drugs, medicaments, antibiotics, nutrients, oral care agents, inhalation materials and the like beneficial agents, compounds fighting against bad smell, food additives, any entity with pharmaceutical activity, etc.

The substance may be a preparation in the form of a proper pharmaceutical preparation, a solution, a tablet, a pill, a gel, grains, powder, capsule, combinations of two or more capsules or the like.

The substances, e.g. tablet or pill, might be inserted into the container manually or automatically. Such methods may be by pressure or by a push, by injection or by an integral production process, all the above with or without welding, ultrasonic welding, snap sealing, heat sealing and/or adhering of the cover if present or any other methods. The substance may be inserted into the container through any side thereof.

The substance may be inserted into the container body and sealed by the cover by the following methods. However it is not restricted thereto:
1. The substance is inserted by pushing or pressure into the container body and thereafter the cover is sealed by adhering.
2. The substance is pressed into the container body by any side thereof and the cover is sealed without adhering. In this possibility no cover is required and the substance may be pressed into the container through any opening thereof.
3. The substance is pressed into the container body and in the center of said substance there is a hole. The cover is sealed by a pin which is inserted through the hole in the substance and closes the container body. In this method the sealing may be also with adhering and/or with additional pins which may be present in the container body and/or in the container cover and opposite said pins are present grooves or holes.
   The sealing as described above is not limited to a substance with a hole.
4. The sealing between the container body and the container cover is performed by snapping or by screwing.

The devices are replaced every period as needed in a simple and convenient way. The devices can be disposable and non disposable. If non-disposable, the patient is able to change or to insert the substance, e.g. a pill, inside.

The cord connects various parts of the device, e.g. two or more parts of the device to each other, e.g. the stopper to the container or various containers to each other in any area of each part of the device or various stoppers to the container, etc. The cord can be a dental floss like material. The cord may be made also from the same material as the container. The support arm if present may be an addition part to the cord. The cord can be string-like or sheet-like, it might be smooth or projective. The cord may have a suitable length. The cord may be elastic, rigid plastic, metallic spring or any other metallic material like metallic with memory or combinations thereof. It may have any suitable form e.g. flattened, round, elliptic, triangle, composed of several cords, etc. More particularly the cord may be manufactured from e.g. non elastomeric commercially available dental floss such as dental floss made out of one or two polymers, either polyamide (nylon) or PTFE (Teflon) or elastomeric fibers, e.g. two polymers can be used instead of conventional dental floss with elastomeric properties such as silicon rubber fibers or polyurethane fibers known as Spandex. Spandex is a generic name of manufactured fibers whose fiber forming substance is a long chain synthetic polymer comprising at least 85% of a segmented polyurethane. Trade names of these fibers are Lycra (DuPont), Dorlostan (Bayer), Spanzelle (Courtaulds), Vyrene (US Rubber), etc. Spandex fibers are highly stretch and elastic as rubber, stronger than rubber, and resistant to aging.

The stopper may be made from the same material and/or may have the same form as the cord but may also differ from same, e.g. may be a pad, etc. The stopper inter alia may have the form of a conus, a rectangle, a triangle, a line thread, etc. Furthermore the stopper, as indicated above, may be made from the same material as the cord and the container and may also be made from nylon, metal, various plastics, rubber, etc. More particularly the stopper may be manufactured from an ethylene based octane plastomer (metallocene) film, e.g. Exact 0201 (Exxon) with excellent puncture resistance and toughness. The stopper of the present invention as indicated above may be part of the cord or may be connected to the cord by any connecting means such as adhering, squeezing, threading, knotting, etc.

The device in accordance with the present invention may be manufactured by any available process. However, it may be manufactured in accordance with the following procedure without being limited to said procedure:
1. The stopper is manufactured by extrusion.
2. The container film is manufactured by co-extrusion preferably three layers film.
3. The device having the substance is manufactured as follows:
   The substance is placed between two three-layered sheets and perforated in advance by means of a puncher; the cord is extruded between the two sheets; the container is soldered when the substance and the cord are located in the proper places; the soldering is done by a heated puncher which solders but does not punch, in order to protect the cord. Alternatively it is possible to create a cut during soldering and to extrude the cord after the soldering and the cutting.
4. Thereafter the stopper is cut into discs and the cord is extruded by its ends into the discs and soldering the ends of the cord with the help of hot adhesive (Ethylene vinyl acetate copolymer).

The device in accordance with the present invention should preferably be anchored in the mouth.

The anchorage point may be located directly on teeth or indirectly to implements that are inserted in the oral cavity such as dental prostheses, (partial or full) hooks, orthodontic appliances, bridges or crowns or to any other tools that are located in the oral cavity.

The anchorage point may be located between at least two teeth, groove in a plate, a carrier of a single tooth in various forms, a clip, etc.

The device in accordance with the present invention may be inserted into the anchorage point directly or via helping tool, e.g. an applicator.

The device according to the present invention may be anchored in one of the following manners: (however, the devices are not restricted to said manner)
a. (1) The anchorage of the device is performed with the assistance of the cord. The elastic cord is lengthened (stretched position) and then inserted in between the contact point of 2 proximate adjacent teeth or more contact points. Said action may be repeated between two other adjacent teeth if required. After releasing the device, the cord returns to its prior size (relaxed position). This enables to insert the device to its proper position and to be anchored properly.
   The device may be anchored in any place on the upper or lower jaws between any front teeth or back teeth, preferably adjacent teeth.
   (2) Should the cord material of (1) above not be elastic then it should simply be inserted between two adjacent teeth. Also in this case in a preferred embodiment the anchorage is performed in two areas, namely the contact points is between each set of two teeth.
b. The anchorage is achieved by springiness of the cord that holds the two parts of the device in a sort of tight junction;
c. The anchorage is achieved by the springiness of the container or part of the container or combination of both the cord and the container;
d. The anchorage is achieved by a dental floss like cord that is inserted between the teeth;
e. The anchorage is achieved by a combination of the cord and a “nit” junction. One part is inserted into the other as a “nit” in the inter proximal space;
f. The anchorage is achieved by using a long cord that can by inserted as “s” shape around two or more adjacent teeth;
g. The anchorage can be achieved by use of spring arms that grip the tooth. The grippers might be soft or rigid;
h. The anchorage can be achieved by a bow or by a bridge limb that is in addition to the cord. The bow keeps the cord from causing pressure on the gums. The bow may be made from plastic materials, elastomers and/or a metal; and
i. The anchorage can be achieved by a cord having the form of a rubber/elastic band around one or several teeth.

The present invention will now be illustrated with reference to the accompanying drawings and examples without being limited by them. Identical parts are marked by the same numerals.

In said drawings:

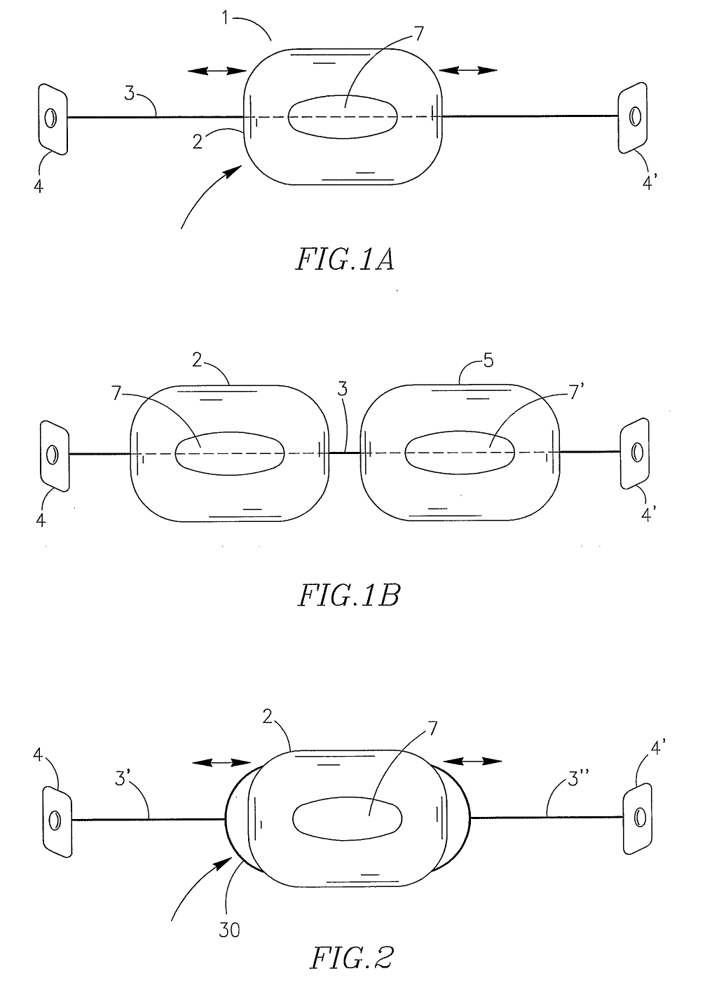

FIG. 1A shows a perspective view of the device in accordance with the present invention having one elastic container and two stoppers.

FIG. 1B shows a perspective view of another device in accordance with the present invention in having two containers and two stoppers.

FIG. 2 shows a perspective view of another device in accordance with the present invention having one container connected on both sides via an elastic support arm to a cord and stopper.

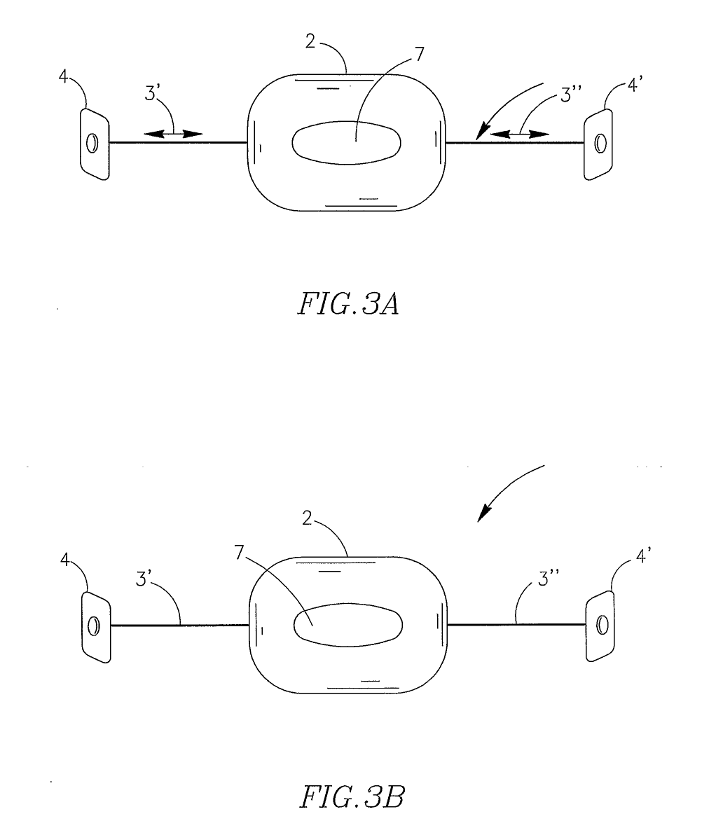

FIG. 3A shows a perspective view of another device in accordance with the present invention having one rigid container and two stoppers.

FIG. 3B shows a perspective view of another device in accordance with the present invention in having one rigid container and two stoppers.

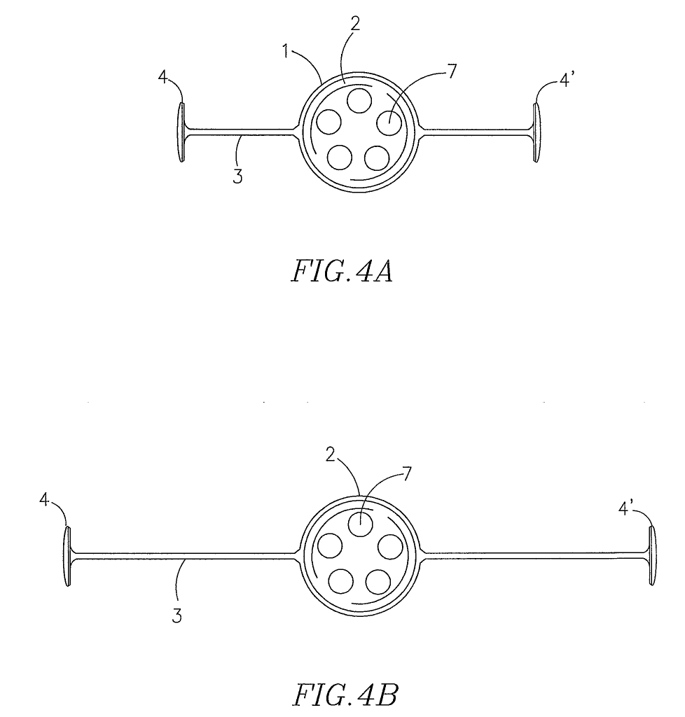

FIG. 4A shows a perspective view of another device in accordance with the present invention in the relaxed position having one container and two stoppers.

FIG. 4B shows a perspective view of the device in FIG. 4A in the stretched position having one container and two stoppers.

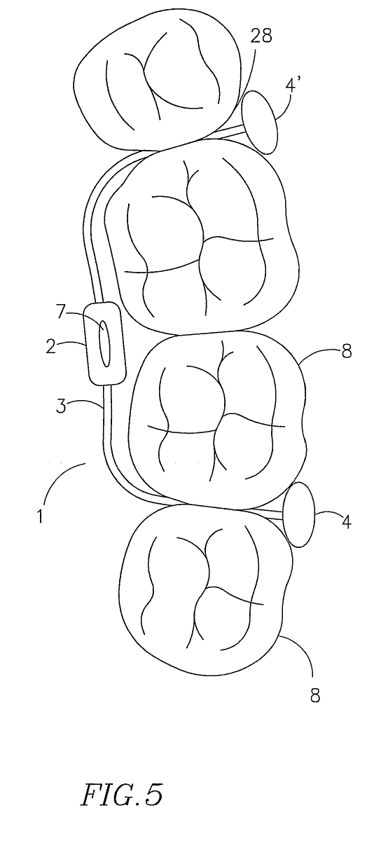

FIG. 5 shows a perspective view of a device in accordance with the present invention as anchored between the teeth.

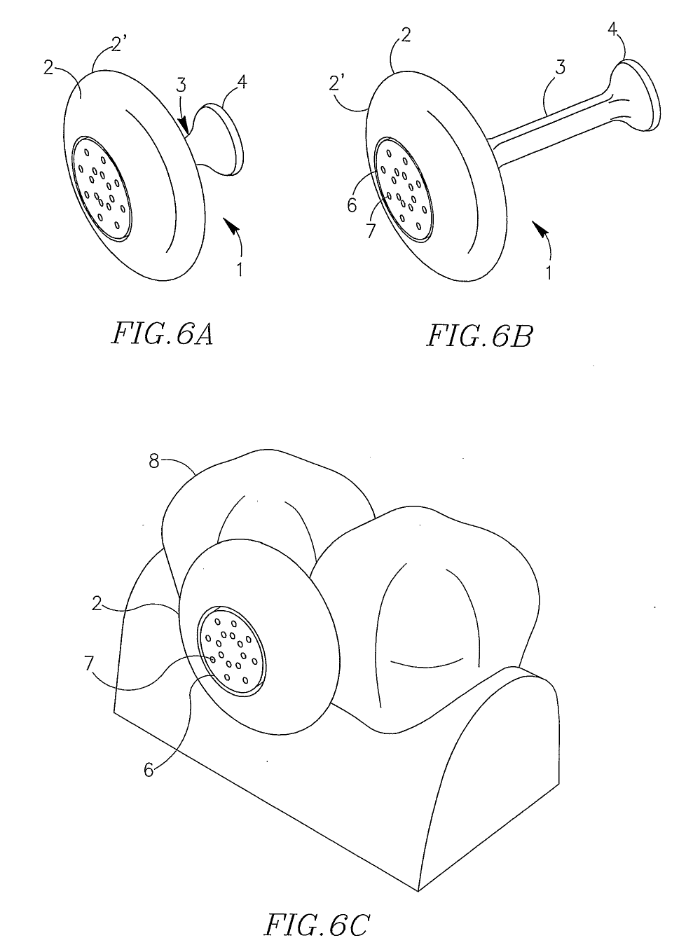

FIG. 6A shows a perspective view of another device in accordance with the present invention in the relaxed position;

FIG. 6B shows a perspective view of FIG. 6A in the stretched position;

FIG. 6C shows a side view of the location of the device of FIGS. 6A and 6B;

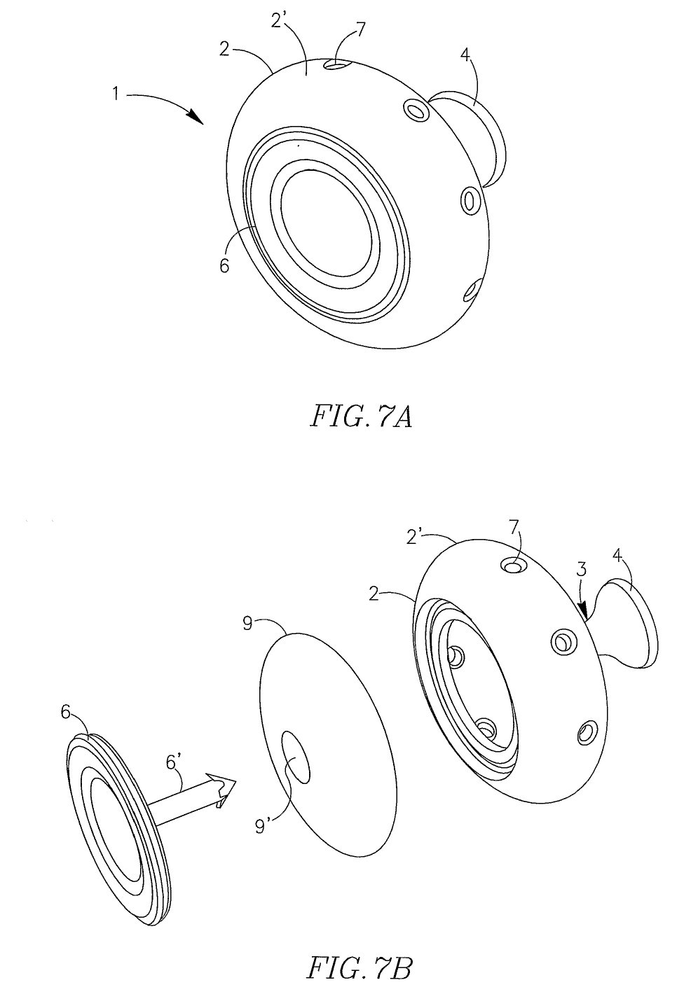

FIG. 7A shows a perspective view of another device in accordance with the present invention in the relaxed position;

FIG. 7B shows an exploded view of the device of FIG. 7A;

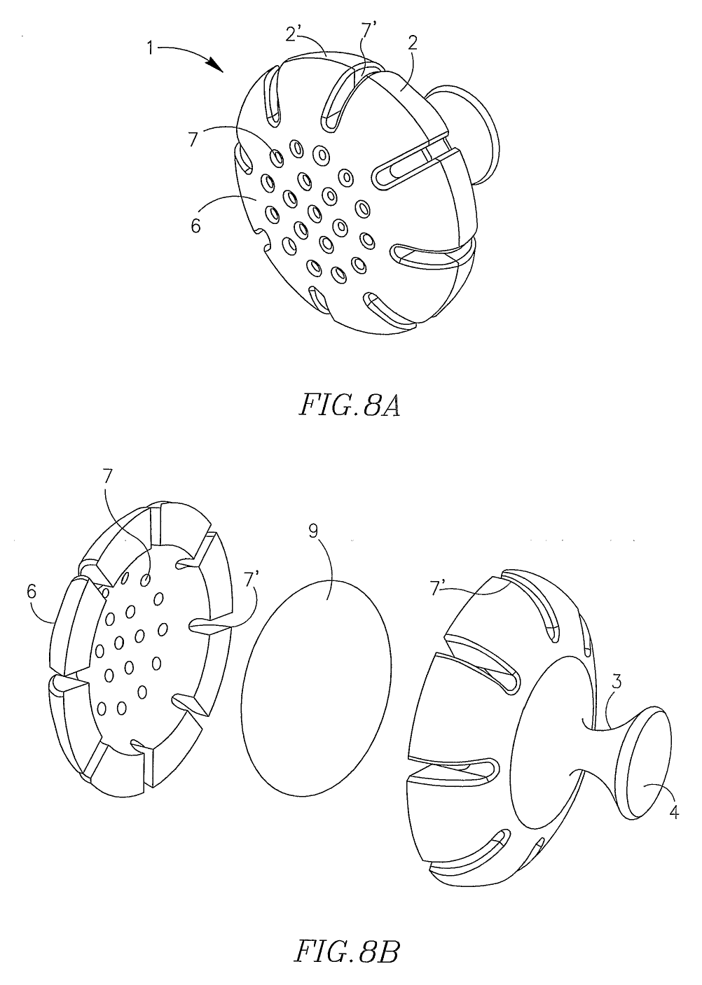

FIG. 8A shows a perspective view of another device in accordance with the present invention in the relaxed position;

FIG. 8B shows an exploded view of the device of FIG. 8A;

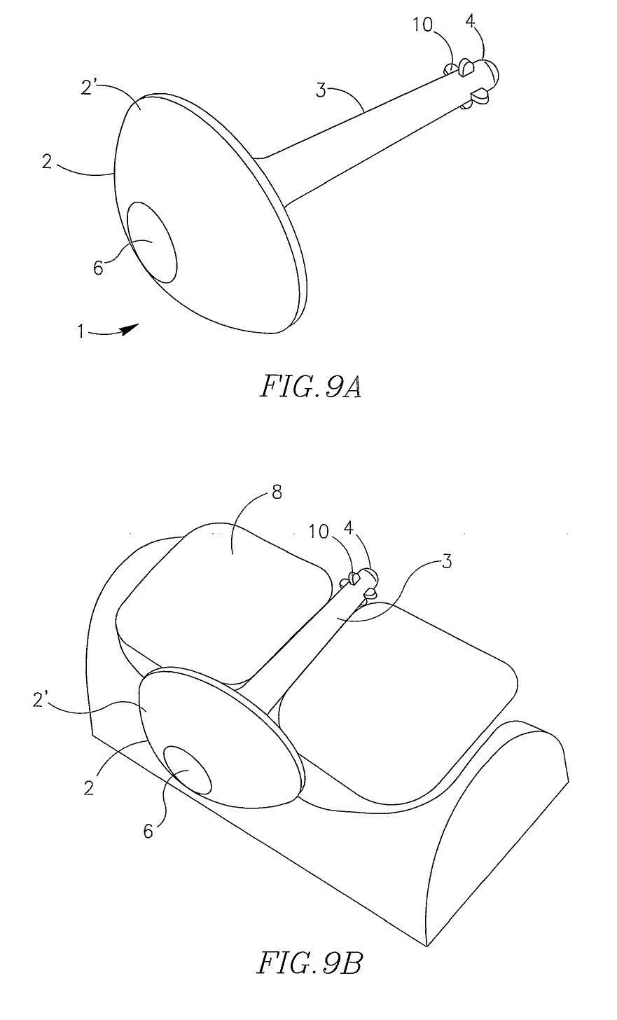

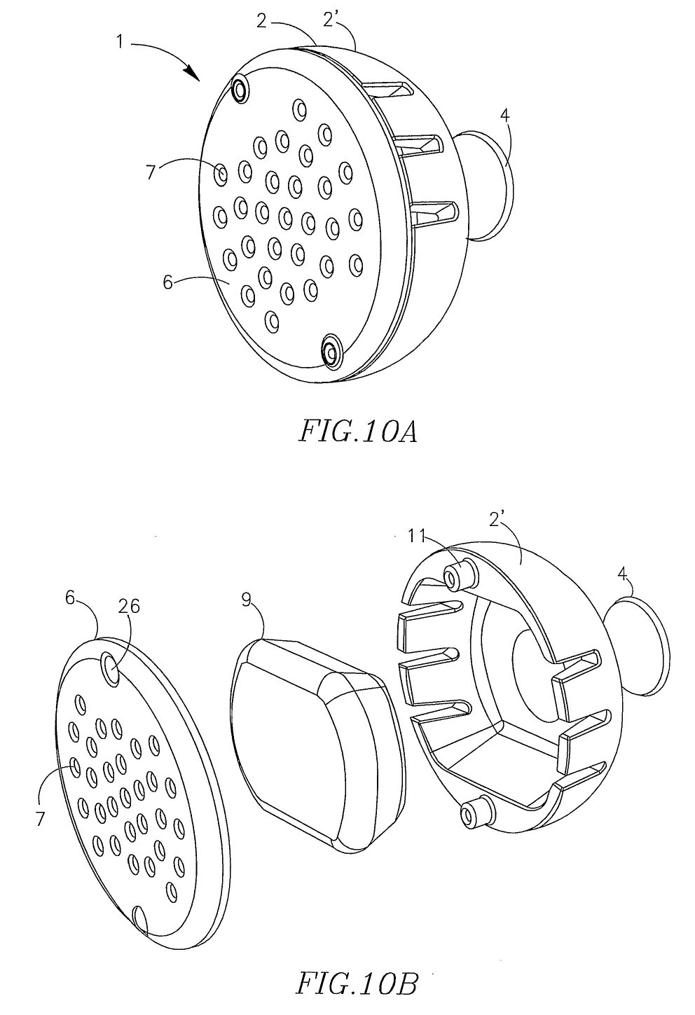

FIG. 9A shows a perspective view of another device in accordance with the present invention having a non-elastic cord;

FIG. 9B shows a perspective view of the location of the device of FIG. 9A;

FIG. 10A shows a perspective view of another device in accordance with the present invention in the relaxed position;

FIG. 10B shows an exploded view of the device of FIG. 10A;

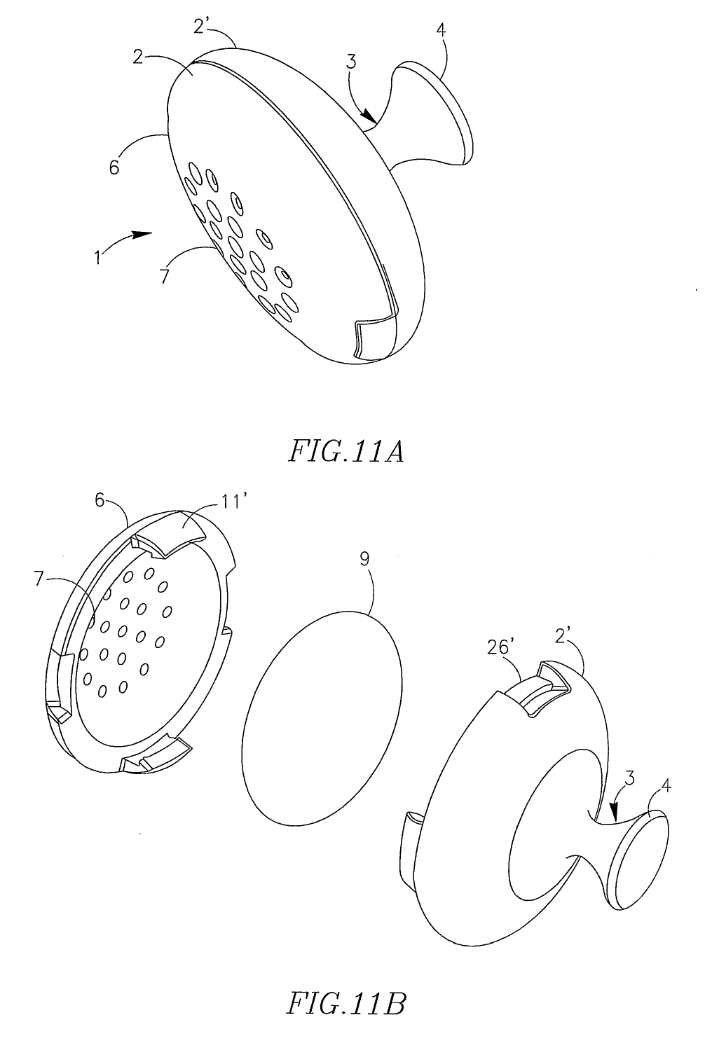

FIG. 11A shows a perspective view of another device in accordance with the present invention in the relaxed position;

FIG. 11B shows an exploded view of the device of FIG. 11A;

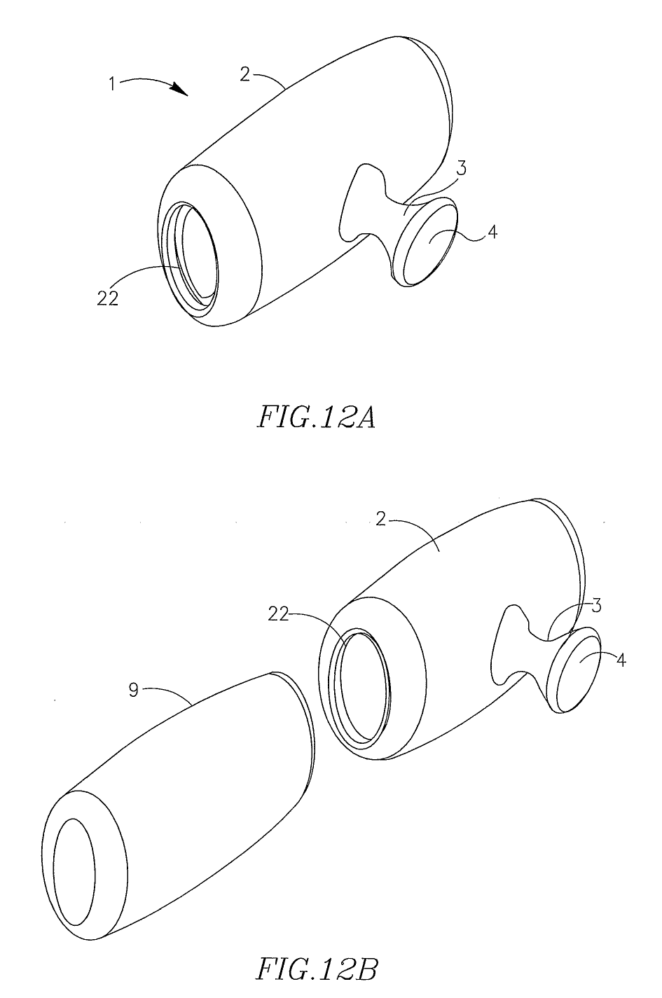

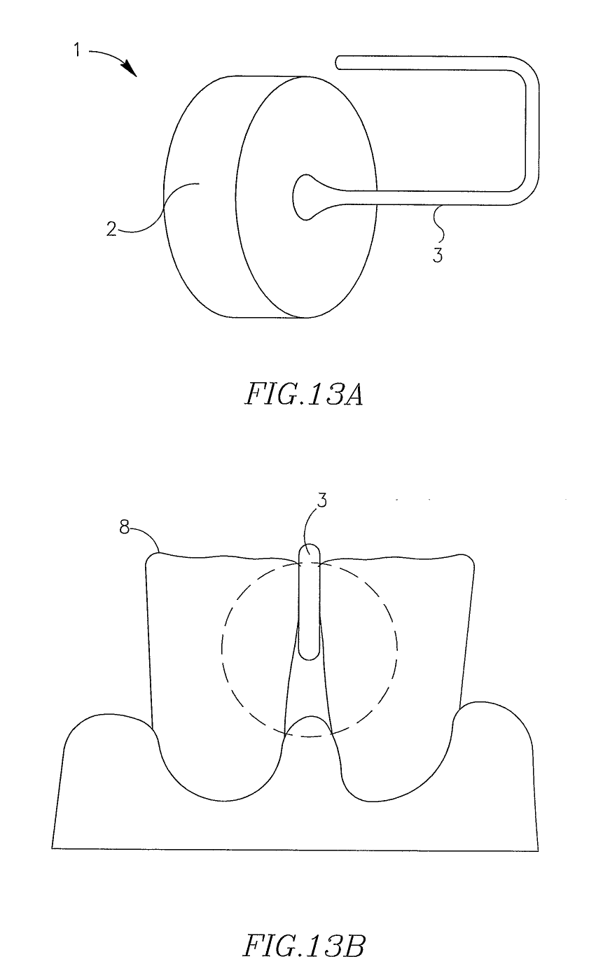

FIG. 12A shows a perspective view of another device in accordance with the present invention in the relaxed position;

FIG. 12B shows the device of FIG. 12A together with the substances before inserting same;

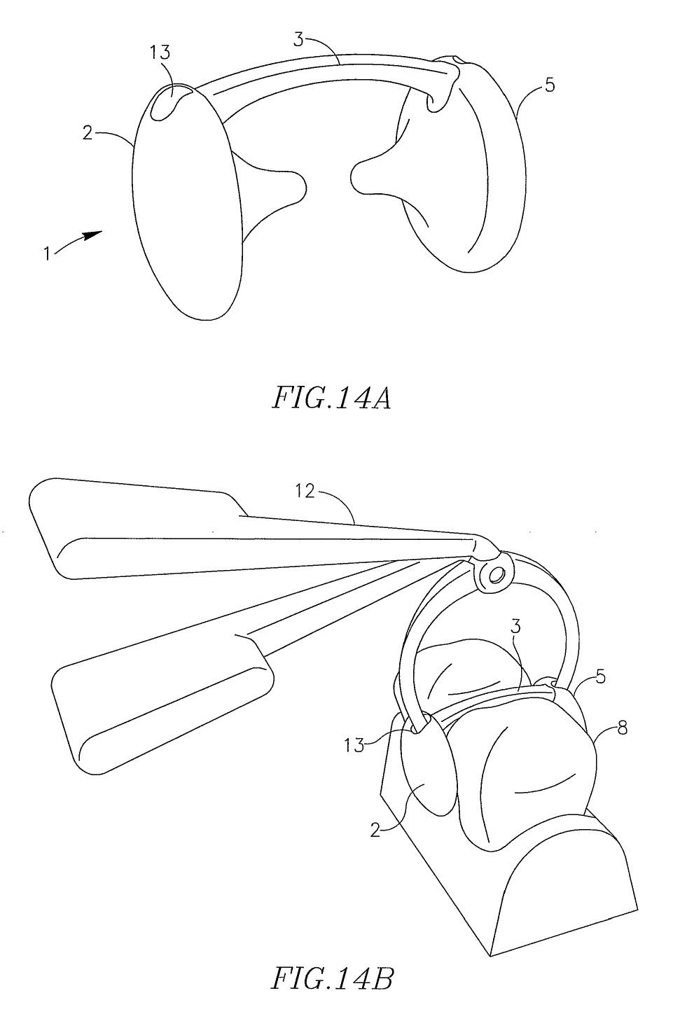

FIG. 13A shows a side view of another device in accordance with the present invention having a cord with a hook-shaped form;

FIG. 13B shows a side view of the location of the device of FIG. 13B;

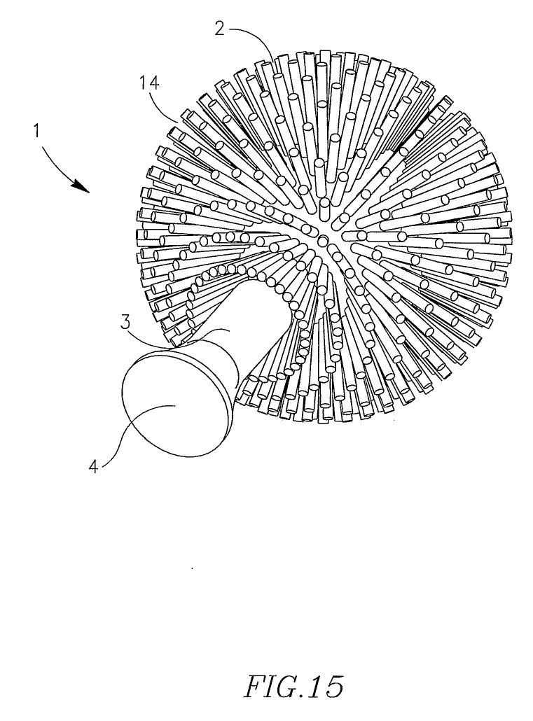

FIG. 14A shows a side view of another device in accordance with the present invention having a cord made of hard material with springable character and wherein on each side of the cord is located one container;

FIG. 14B shows a perspective view of the location of the device of FIG. 14A together with a tool, e.g. an applicator;

FIG. 15 shows a side view of another device in accordance with the present invention having a container with projections;

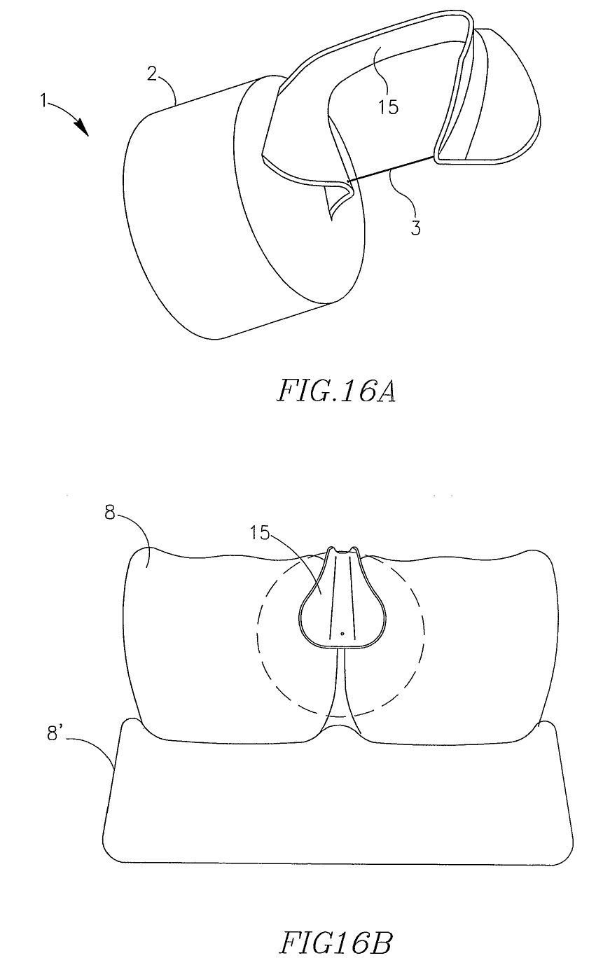

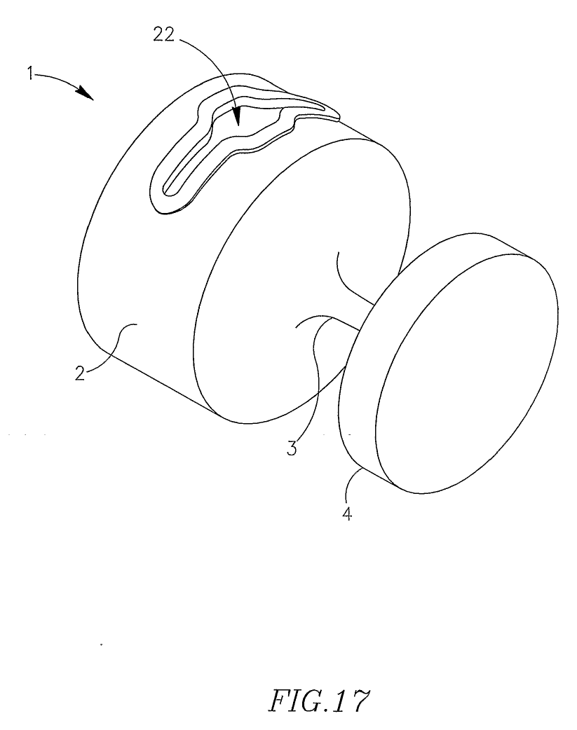

FIG. 16A shows a perspective view of another device in accordance with the present invention having another form of support arm;

FIG. 16B shows a side view of the location of the device of FIG. 16A;

FIG. 17 shows a perspective view of another device in accordance with the present invention in the relaxed position, e.g. having a short cord in which the opening for inserting the substance is on top;

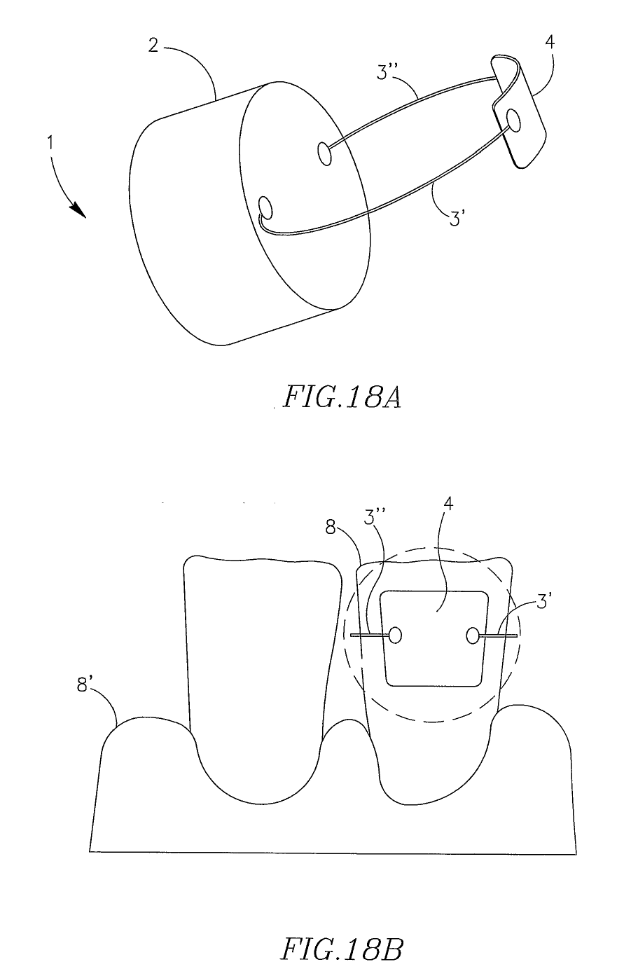

FIG. 18A shows a perspective view of another device in accordance with the present invention in which the cord consists of two cords wherein the stopper is a pad;

FIG. 18B shows a side view of the location of the device of FIG. 18A.

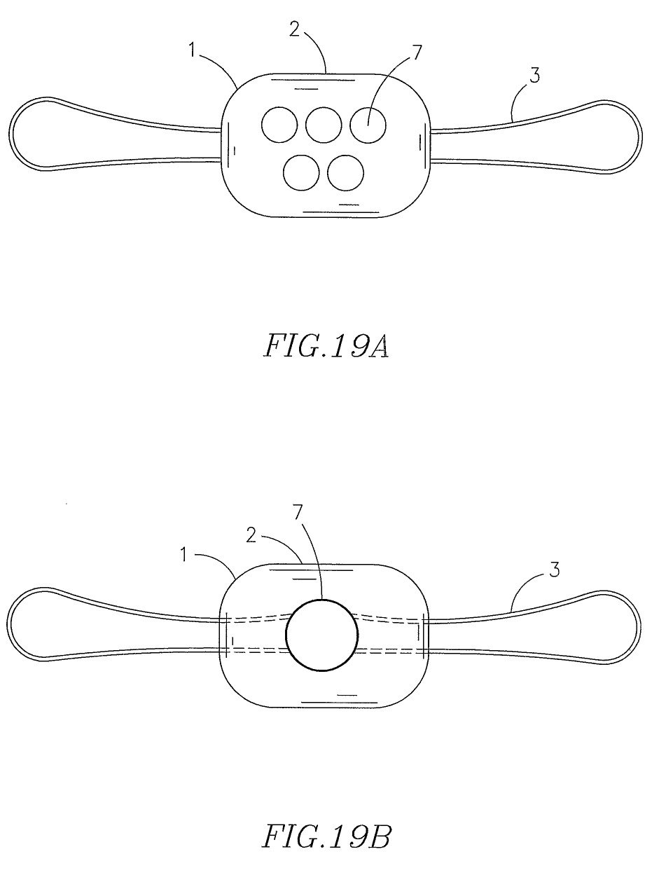

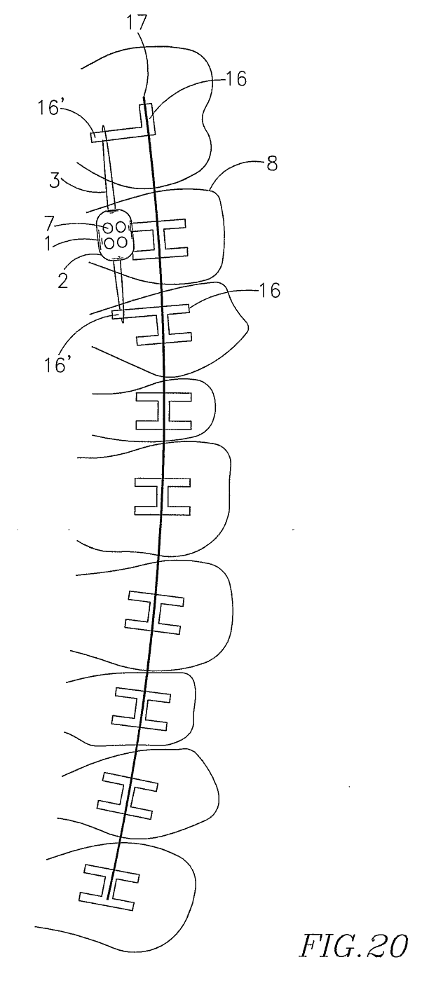

FIG. 19A shows a front view of another device comprising one container and a cord in the form of a loop which is similar to the device of FIG. 18A.

FIG. 19B shows the device of FIG. 19A which illustrates the part of the cord inside of the container.

FIG. 20 shows a front view of an orthodontic device having a device in accordance with FIGS. 19A and 19B.

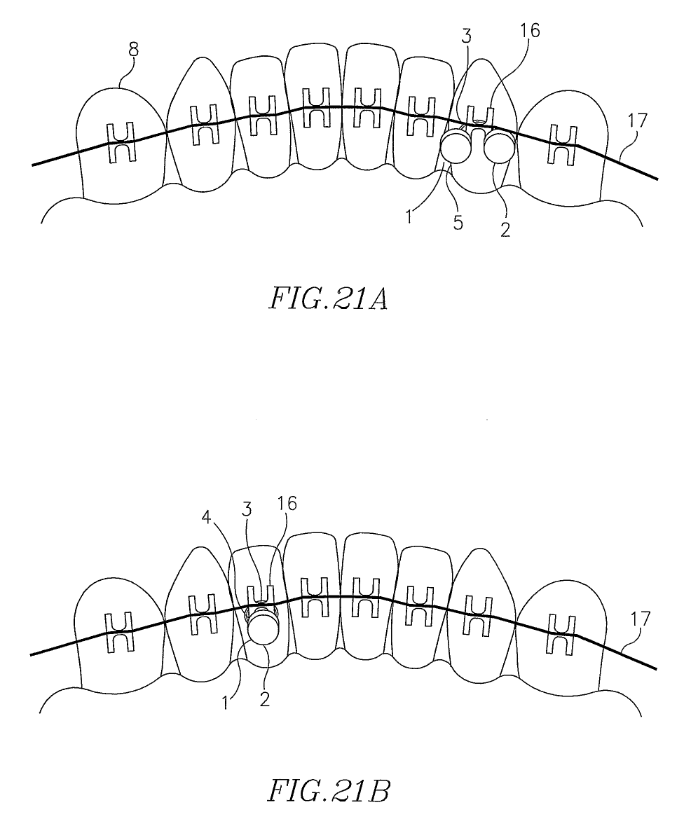

FIG. 21A shows a front view of an orthodontic device comprising a device in accordance with the present invention having two containers; and

FIG. 21B shows a front view of an orthodontic device comprising a device in accordance with the present invention having one container.

More particularly, in said Figures are shown various devices 1 consisting in container 2, cord 3, and/or cord 3′, and/or stopper 4 and/or stopper 4′ and/or second container 5.

In FIG. 1A is shown elastic container 2 having hole 7 through which the substance is released. Container 2 is connected on both sides via non-elastic cord 3 to stopper 4 and to stopper 4′. The elasticity of container 2 is illustrated by the arrows.

In FIG. 1B is shown two containers, 2 and 5, each container having holes 7 and 7′ respectively. Container 2 is connected to container 5 via cord 3. Container 2 is connected on the other side to stopper 4 whereas container 5 is connected on the other side to stopper 4′.

In FIG. 2 is shown container 2 having hole 7. Container 2 is connected on both sides via elastic support arms 30 to non-elastic cords 3′ and 3″. In return cords 3′ and 3″ are connected to stopper 4 and stopper 4′. The elasticity of arm 30 is illustrated by the arrows.

In FIG. 3A is shown non-elastic container 2 having hole 7. Container 2 is connected on both sides via elastic cords 3′ and 3″ to stopper 4 and to stopper 4′. The elasticity of cords 3′ and 3″ is illustrated by the arrows.

In FIG. 3B is shown non-elastic container 2 having hole 7. Container 2 is connected on both sides via non-elastic cords 3′ and 3″ to stopper 4 and to stopper 4′.

In FIG. 4A is shown device 1 in the relaxed position. Moreover, said Fig. shows container 2 having holes 7. Container 2 is connected on both sides via cord 3 to stopper 4 and to stopper 4′.

In FIG. 4B is shown device 1 of FIG. 4A in the stretched position.

In FIG. 5 is shown device 1 as anchored between teeth 8, i.e. elastic cord 3 is inserted between two contact points 28 of two approximate adjacent teeth 8.

In FIGS. 6A and 6B are shown container 2 having container body 2′ and cover 6 comprising holes 7. Container 2 is connected via cord 3 to stopper 4.

In FIGS. 6A, 6B and 6C the anchorage of device 1 is performed with the assistance of cord 3. Elastic cord 3 is lengthened as shown in FIG. 6B and then inserted in between contact point of 2 proximate adjacent teeth 8 as shown in FIG. 6C. After releasing device 1, cord 3 returns to its prior size as shown in FIG. 6A. This enables to insert the device to its proper position and to be anchored properly;

The substance [not shown] in device 1 of FIGS. 6A, 6B and 6C is inserted by pushing into the container body 2′ and sealing it by cover 6.

In FIGS. 7A and 7B are shown container 2 having container body 2′ and cover 6. Around the surface of container body 2′ are located holes 7. Container 2 is connected via cord 3 to stopper 4.

Substance 9 in device 1 of FIGS. 7A and 7B is inserted by pushing into the container body 2′ and sealing it by cover 6. Furthermore cover 6 has pin 6′ which is inserted through hole 9′ of substance 9 in order to seal cover 6 with container body 2′.

In FIGS. 8A and 8B are shown container 2 having container body 2′ comprising holes 7′ and cover 6 comprising both holes 7 and holes 7′. Container 2 is connected via cord 3 to stopper 4. The sealing may be by welding, adhering etc. Both holes 7 and holes 7′ are for releasing substance 9 through container body 2′ and cover 6.

Substance 9 in device 1 of FIGS. 8A and 8B is inserted by pushing into the container body 2′ and sealing it by cover 6. The sealing may be by welding, adhering etc.

In FIGS. 9A and 9B are shown container 2 having container body 2′ and cover 6, Container 2 is connected via rigid cord 3 to stopper 4 having projections 10.

In FIGS. 9A and 9B the anchorage of device 1 is performed with the assistance of cord 3 and projection 10 of stopper 4. The anchorage is achieved by inserting the device from the side of teeth 8.

Container body 2′ with cover 6 are sealed together by a heat sealing method.

In FIGS. 10A and 10B are shown container 2 having container body 2′ and cover 6, Container 2 is connected via cord 3 (not shown) to stopper 4. Container body 2′ has pins 11 which are inserted into cover 6 through holes 26 in the sealing method.

Substance 9 in device 1 of FIGS. 10A and 10B is inserted by pushing/placing into the container body 2′ and sealing it by cover 6 having holes 7. The sealing may be by welding, adhering etc.

In FIGS. 11A and 11B are shown container 2 having container body 2′ and cover 6, Container 2 is connected via cord 3 to stopper 4. Container cover 6 has pins 11′ which are inserted into container body 2′ having grooves 26′ in the sealing method which is a so-called snapping method.

Substance 9 in device 1 of FIGS. 11 and 11B is inserted by pushing/placing into the container body 2′ and sealing it by cover 6.

In FIGS. 12A and 12B are shown device 1 in the type of an elastomer pipe in which container 2 is having an elliptical form. Substance 9 is pushed from the side through opening 22 into container body 2′.

FIGS. 13A and 13B show container 2 connected to cord 3 having the form of a hook which hook serves also as the stopper.

In FIGS. 13A and 13B the anchorage of device 1 is performed with the assistance of cord 3. The anchorage is achieved by hooking by cord 3 teeth 8.

FIGS. 14A and 14B show device 1 having containers 2 and 5 connected by cord 3. Said device is inserted by applicator 12 between teeth 8. Applicator 12 is connected to device 1 through holes 13.

FIG. 15 shows device 1 in which container 2 consists in projections and ledges 14 and is connected to stopper 4 via cord 3.

FIGS. 16A and 16B show container 2 having cord 3 and support arm 15. Said support arm 15 prevents recession of device 1 into gums 8′. Stopper 4 in this case is part of support arm 15. Device 1 is anchored by support arm 15 and teeth 8.

FIG. 17 shows device 1 comprising container 2 connected via cord 3 to stopper 4. Container 2 has at its upper part opening 22 for the insertion of the substance [not shown].

FIGS. 18A and 18B show device 1 which comprises container 2 which is connected to stopper 4 by cord 3 which consists in two cords 3′ and 3″. As in other Figs. and Examples of the present invention the cord may be only one cord which passes through the stopper and/or the container. In this case stopper 4 is in the form of a pad. The anchorage of device 1 is by inserting cord 3′ and 3″ around teeth 8 like a rubber band. Stopper 4 prevents the descending of device 1 under gums 8′.

In FIGS. 19A and 19B are shown device 1 consisting in container 2 and holes 7. Container 2 is connected to Cord 3 which is in the form of a loop.

Device 1 of FIGS. 19A and 19B is similar to device 1 as shown in FIGS. 18A and 18B with the difference that in FIGS. 18A and 18B stopper 4 is in the form of a pad and two cords are present.

In FIG. 20 is shown bracket 16 having hook 16′ on each tooth 8 through which orthodontic wire 17 is passed. Device 1 of FIGS. 19A and 19B is attached by cord 3 to hook 16′.

In FIGS. 21A and 21B are shown brackets 16 on each tooth 8 through which orthodontic wire 17 is passed. Device 1 is attached to wire 17 and bracket 16 by cord 3. In FIG. 21A device 1 comprises container 2 and container 5 whereas in FIG. 21B device 1 comprises container 2 and stopper 4.

### EXAMPLES

### Example 1

### The Manufacture of the Container

The container is made of a three layered film produced by coextrusion. The layers were made of two types of polymers:

1. Engage 8500: polyolefin metallocene elastomer.
2. Kraton G 1657M: linear triblock copolymer based on styrene and ethylene/butylenes, with a styrene content of 13%.

The film produced is symmetric: Engage (50 μm)/Kraton 700 μm)/Engage (50 μm).

The three layered film is manufactured by the extruder cast with the following data:

| | | Zone1 | Zone2 | Zone3 | Zone4 |
|---|---|---|---|---|---|
| | rpm | (° C.) | (° C.) | (° C.) | (° C.) |
| Engage | 15 | 180 | 190 | 210 | 215 |
| Kraton | 100 | 200 | 210 | 230 | 215 |
| Engage | 15 | 180 | 190 | 210 | 215 |

### Example 2

### The Manufacture of the Stopper

### Raw Materials for the Stopper

Exact 0201 (Exxon)—An ethylene based octane plastomer (metallocene) film with excellent puncture resistance and toughness.

The sheet of stopper is manufactured by the extruder cast with the following data:

| | | Zone1 | Zone2 | Zone3 | Zone4 |
|---|---|---|---|---|---|
| | rpm | (° C.) | (° C.) | (° C.) | (° C.) |
| Exact 0201 | 15 | 150 | 180 | 220 | 225 |
| (Exxon) | | | | | |

### Example 3

### Raw Materials for the Cord

Two different approaches can be used with the cord:

1. Non elastomeric commercially available dental floss. Dental floss is commonly made out of one or two polymers, either polyamide (nylon) or PTFE (Teflon).
2. Elastomeric fibers: Two polymers can be used instead of conventional dental floss with elastomeric properties: silicon rubber fibers or polyurethane fibers known as Spandex. Spandex is a generic name of manufactured fibers whose fiber forming substance is a long chain synthetic polymer comprising at least 85% of a segmented polyurethane. Trade names of these fibers are Lycra (DuPont), Dorlostan (Bayer), Spanzelle (Courtaulds), Vyrene (US Rubber), etc. Spandex fibers are highly stretch and elastic as rubber, stronger than rubber, and resistant to aging.

### Example 4

### Manufacture of the Device

1. The sheet of stopper is manufactured by extrusion as defined in Example 2.
2. The container film is manufactured by co-extrusion as defined in Example 1.
3. The container having the substance is manufactured as follows:
   The substance is placed between two three-layered sheets and perforated in advance by means of a puncher. The cord as defined in Example 3 is extruded between the two sheets. The container is soldered at a temperature of about 120° C. when the substance, e.g. the medication and the cord are located in the proper places, e.g. as in FIG. 1. The soldering is done by a heated puncher which solders but does not punch, in order to protect the cord. Alternatively it is possible to create a cut during soldering and to extrude the cord after the soldering and the cutting.
4. Thereafter the stopper is cut into discs and the cord is extruded by its ends into the discs and soldering the ends of the cord with the help of hot adhesive (Ethylene vinyl acetate copolymer).

### Example 5

### Manufacture of the Stopper

The components are:
The cord consisting in a flexible Spandex fiber (alternatively dental floss or synthetic latex may be used)
A small metal tube, e.g. pressing bead, with an exterior diameter of about 1.8 mm, a length of about 1.6 mm and a wall thickness of about 0.2 mm
2 sheets of polyethylene.

The process is performed as follows:

The Spandex fiber, i.e. the cord, is inserted into the tube and creates a knot on the fiber itself.

The tube is pressed using pliers (or alternatively using an industrial roller) next to the knot. The purpose of the knot is to prevent the fiber from passing through the pressed tube during strong stretching.

Afterwards the bead and the fiber between the two layers of polyethylene are pressed and soldering of the layers when the fiber and the bead are between them is performed.

The soldering is done by a metal tube which is heated by a soldering iron and is connected to it. The form of the soldering is round with a diameter of about 3.5 mm.

The final stage is cutting a disk with a diameter of 4.5 mm around the soldering. The cutting in the form of a tube whose lip is sharpened is done by a puncher.

The function of the polyethylene is to be a kind of handle for pulling as well as to hide the bead.

### Example 6

### Manufacture of the Container and the Device in Accordance with Stopper as Manufactured in Example 5

The components are:
The cord consisting in a Spandex fiber 20 mm in length which is connected on its two sides to stoppers as described in Example 5
2 polyethylene sheets punched with 2 mm diameter holes

The process is performed as follows:

The fiber is inserted between two sheets. A circle 9 mm in diameter is soldered by using a heated metal tube (the tube has two grooves at its end in order not to harm the Spandex fiber).

The sheets is cut around the soldering with a 10 mm diameter with a puncher in the form of a tube, which tube has two grooves in its side, for the prevention of harm to the Spandex fiber.

The process described is a manual process.

1. A device for retaining and dispensing substances embedded in the oral cavity.

2. A device according to claim 1 which consists in a device for retaining and dispensing a substance which includes at least one or more containers (reservoirs) which container stores the substance; should only one container be present at least one stopper is also present; and a cord which connects the above components and may function also as an anchorage.

3. A device according to claim 2, wherein the stopper is not part of the cord.

4. A device according to claim 2, wherein the stopper is part of the cord.

5. A device according to claim 2 having also a support arm.

6. A device according to claim 1 which consists of a device which can be safely placed and securely retained in the mouth for a predefined or an undefined period without the need of bonding the device to teeth, to a plate or to any additional device and which stores the substance to be dispensed.

7. A device according to claim 2 in which the container is a storage for all the substances which are to be dispensed.

8. A device according to claim 1 in which the substance is selected among drugs, medicaments, antibiotics, nutrients, oral care agents, inhalation materials and the like beneficial agents, compounds fighting against bad smell, food additives, any entity with pharmaceutical activity, etc.

9. A device according to claim 1, wherein the substance is a preparation in the form of a proper pharmaceutical preparation, a solution, a tablet, a pill, a gel, grains, powder, capsule, combination of two or more capsules or the like.

10. A device according to claim 2 in which the containers, stopper, the cord and support arm, if present, are designed as one component.

11. A device according to claim 2 in which the containers, stopper, the cord and support arm, if present, are designed as different components.

12. A device according to claim 2 wherein the container is designed as one chamber.

13. A device according to claim 2 wherein the container is divided into several chambers.

14. A device according to claim 13 wherein the chambers are segmented by a screen; or by a wall being permeable, non-permeable or semi-permeable.

15. A device according to claim 2 wherein the structure of the container is selected among cylindrical shape, round shape, or a “bagel” shape which shape accommodates the shape and size of the substance.

16. A device according to claim 2 wherein the outer surface of the container is smooth or being provided with/or consists in projections wherein said projections are around the outer surface or only on part of the surface; and/or are symmetrical or asymmetrical.

17. A device according to claim 2 wherein the container is made of a soft and/or flexible material.

18. A device according to claim 17 wherein the container is made of polyurethane, a rubber-like material, a flexible plastic material, etc.

19. A device according to claim 17 wherein the container is made of a material that encapsulates the substance, e.g. a pill like elastomer TPU.

20. A device according to claim 2 wherein the container is made of a rigid material.

21. A device according to claim 2 wherein the container is made from Biomedical silicons, Biomedical thermoplastic polyurethanes, Polyethylene and Ethylene vinyl acetate (EVA).

22. A device according to claim 2 wherein the container is made from three layered film.

23. A device according to claim 22 wherein the container is made from 3 layered film produced by co-extrusion.

24. A device according to claim 2 wherein the container is composed of a container body and a container cover.

25. A device according to claim 2 wherein the container is having an opening for the insertion of the substance.

26. A device according to claim 2 in which the container comprises a membrane or consists in any material or compound which can control the release of the required substances.

27. A device according to claim 2 in which the container comprises at least one hole or perforation in any part of its surface.

28. A device according to claim 2 wherein the substance is inserted into the container of the device manually or automatically.

29. A device according to claim 28 in which the methods are selected among pressure, a push, injection or an integral production process, all the above with or without welding, ultrasonic welding, snap sealing, heat sealing and/or adhering of the cover if present or any other methods.

30. A device according to claim 2 wherein the substance is inserted into the container through any side thereof.

31. A device according to claim 2, wherein the cord has any suitable length.

32. The device according to claim 2, wherein the cord is string-like or sheet-like and it is smooth or projective.

33. A device according to claim 2 which comprises a cord which is made of an elastic, rigid plastic, metallic spring or any other metallic material like metallic with memory or combinations thereof; and It has any suitable form selected among flattened, round, elliptic, triangle and/or composed of several cords.

34. A device according to claim 2 which comprises a cord which is made of a dental floss like material.

35. A device according to claim 2 which comprises a cord which is made from the same material as the container.

36. A device according to claim 2 wherein the cord is made from non elastomeric commercially available dental floss selected among dental floss made out of one or two polymers, either polyamide (nylon) or PTFE (Teflon) or elastomeric fibers, selected among conventional dental floss or two polymers with elastomeric properties, e.g. silicon rubber fibers or polyurethane fibers known as Spandex.

37. A device according to claim 2 wherein the cord connects the various parts of the device, e.g. container(s) and/or stopper(s) in any area of the parts.

38. A device according to claim 2 which comprises a stopper which is made from the same material and/or may have the same form as the cord and/or container but may also differ from same.

39. A device according to claim 2 wherein the stopper is in the form of a conus, a rectangle, a triangle or a line thread.

40. A device according to claim 2 wherein the stopper is made from nylon, metal, various plastics, rubber or combinations thereof.

41. A device according to claim 2 wherein the stopper is manufactured from an ethylene based octane plastomer (metallocene) film with excellent puncture resistance and toughness.

42. A device according to claim 2 wherein the stopper is connected to the cord by any connecting means such as adhering, squeezing, threading or knotting.

43. A device in according to claim 1 which is disposable.

44. A device according to claim 2, wherein the container is placed on one or more sides of the cord.

45. A device according to claim 44, wherein at least one container is located on the cord between two stoppers.

46. A device according to claim 44, wherein the cord is inserted through the container(s).

47. A device according to claim 44, wherein at least one container is located between at least two cords, and at the end of each cord is located a stopper.

48. A device according to claim 44, wherein one container is located on one side of the device, i.e. of the cord and the stopper is located on the second side of the cord.

49. A device according to claim 44 wherein on each side of the device, i.e. of the cord is located one container.

50. A device according to claim 44 wherein on each side of the device, i.e. of the cord are located one or more container(s).

51. A device according to claim 44, wherein the container is moving along the cord

52. A device according to claim 44, wherein the container is in a fixed position in relation to the cord.

53. A device according to claim 2, wherein the container (reservoir) comprises a dosage form adapted for pulsatile, delayed immediate, controlled, or any combination of delivery patterns, e.g. by passive control delivery, diffusion, erosion, osmotic, or any other mechanism or combination.

54. A device according to claim 53 in which a second drug container (reservoir) is present, which container comprises a dosage form which is coated by a special functional coating, designed to delay the delivery from the second container (reservoir) until the dosage form of the first container (reservoir) is empty.

55. A device in according to claim 1 which is anchored in the mouth.

56. A device according to claim 1 wherein the anchorage point is between at least two teeth, groove in a plate, a carrier of a single tooth in various forms and a clip.

57. A device according to claim 55 wherein the device is inserted into the anchorage point directly or via a helping tool.

58. A device according to claim 2 in which the device is anchored by stretching two sides so that the elastic cord is lengthened and then inserted at least once in between the contact point of 2 proximate adjacent teeth; after releasing the device, the cord returns to its prior size.

59. A device according to claim 2 in which the cord is non-elastic and the device is simply inserted at least once in between two adjacent teeth.

60. A device according to claim 2 which may be inserted by pushing it as a tooth pick.

61. A device according to claim 2 which is anchored in one of the following manners:
a. (1) The anchorage of the device is performed with the assistance of the cord. The elastic cord is lengthened (stretched position) and then inserted in between the contact point of 2 proximate adjacent teeth or more contact points.
Said action may be repeated between two other adjacent teeth if required. After releasing the device, the cord returns to its prior size (relaxed position). This enables to insert the device to its proper position and to be anchored properly.
The device may be anchored in anyplace on the upper or lower jaws between any front teeth or back teeth, preferably adjacent teeth.
(2) Should the cord material of (1) above not be elastic then it should simply be inserted between two adjacent teeth. Also in this case in a preferred embodiment the anchorage is performed in two areas, namely the contact between each set of two teeth.
b. The anchorage is achieved by springiness of the cord that holds the two parts of the device in a sort of tight junction;
c. The anchorage is achieved by the springiness of the container or part of the container or combination of both the cord and the container;
d. The anchorage is achieved by a dental floss like cord that is inserted between the teeth;
e. The anchorage is achieved by a combination of the cord and a “nit” junction. One part is inserted into the other as a “nit” in the inter proximal space;
f. The anchorage is achieved by using a long cord that can by inserted as “s” shape around two or more adjacent teeth;
g. The anchorage is achieved by use of spring arms that grip the tooth. The grippers might be soft or rigid;
h. The anchorage is achieved by a bow or by a bridge limb that is in addition to the cord; the bow keeps the cord from causing pressure on the gums; the bow may be made from plastic materials, elastomers and/or a metal; and
i. The anchorage is achieved by a cord having the form of a rubber/elastic band around one or several teeth.

62. A device according to claim 1 for retaining and dispensing substances intraorally for sustained-controlled release by the saliva in an advance period of time and for devices for use within the mouth as an effective long-term oral and gastric retention device.

63. A device according to claim 1 which comprises a device for patients who have orthodontic treatment or instrumentation.

64. A device according to claim 63 wherein the orthodontic treatment is performed as follows:
After having the orthodontic device on the tooth, the physician and/or the patient will apply the device, e.g. by the cord around at least one hook, preferably two hooks, which hook is located respectively on a bracket.

65. A device according to claim 63 wherein the orthodontic treatment is performed as follows:
After sticking the brackets on each tooth and before inserting the orthodontic wire, the physician will apply the device, i.e. via its cord, around at least one bracket which is chosen and the wire will hold the device in its place.

66. A device according to claim 1 which is retained in the mouth for a long time; which releases any substances for sustained action.

67. A device according to claim 1 wherein said device is replaced by another device at any required time.

68. Use of the device according to claim 1 for the administration of substances through the mouth; wherein said substances are used against mouth diseases and side effects in the mouth, nutrition as well as for the diseases and nutrition of the G.I. tract to deliver biologically entities with pharmacological activity.

69. The manufacture of a device in accordance with claim 1 with the following steps:
1. The stopper is manufactured by extrusion.
2. The container film is manufactured by co-extrusion preferably three layers film.
3. The device having the substance is manufactured as follows:
The substance is placed between two three-layered sheets and perforated in advance by means of a puncher; the cord is extruded between the two sheets; the container is soldered when the substance and the cord are located in the proper places; the soldering is done by a heated puncher which solders but does not punch, in order to protect the cord. Alternatively it is possible to create a cut during soldering and to extrude the cord after the soldering and the cutting.
4. Thereafter the stopper is cut into discs and the cord is extruded by its ends into the discs and soldering the ends of the cord with the help of hot adhesive (Ethylene vinyl acetate copolymer).

70. A device for retaining and dispensing substances embedded in the oral cavity substantially as described in the accompanying drawings.
